(19) United States
(12) Patent Application Publication
(10) Pub. No.: US 2014/0143107 A1
(43) Pub. Date: May 22, 2014

(54) MOBILE PAYMENT SERVICE FOR HELPING CONSUMER TO CHOOSE PAYMENT CARD

(71) Applicant: KT CORPORATION, Gyeonggi-do (KR)

(72) Inventors: Han-Na KIM, Seoul (KR); Chi-Young PARK, Seoul (KR)

(73) Assignee: KT CORPORATION, Gyeonggi-do (KR)

(21) Appl. No.: 14/082,383

(22) Filed: Nov. 18, 2013

(30) Foreign Application Priority Data
Nov. 16, 2012 (KR) 10-2012-0130438

(51) Int. Cl. G06Q 20/22; G06Q 20/32; G06Q 20/12

(52) U.S. Cl. CPC G06Q 20/227; G06Q 20/12; G06Q 20/322
USPC 705/35

(57) ABSTRACT

The disclosure is related to a service for helping a consumer to select a payment card returning the relatively best benefits among multiple payment cards of the consumer without requiring user equipment for collecting a large amount of information and for performing excessive amount of computation. The user equipment may be configured to obtain a merchant identification code from a target merchant, to request a modularized code block associated with the obtained merchant identification code to a service server, to receive a modularized code block associated with the merchant identification code from the service server, and to display information on beneficial payment cards associated with the target merchant in a designated display area of a user interface of a service application, installed in and executed by the user equipment, by processing the received modularized code block.

### CROSS REFERENCE TO PRIOR APPLICATIONS

The present application claims priority under 35 U.S.C. §119 to Korean Patent Application No. 10-2012-0130438 (filed on Nov. 16, 2012), which is hereby incorporated by reference in its entirety.

### BACKGROUND

Lately, consumers are able to make payments through various types of payment means including payment cards. The payment card is a card that might be used by a consumer and accepted by a merchant to make a payment for purchasing a good or a service. The payment card includes a credit card, a debit card, an automated teller machine (ATM), a charge card, a stored-value card, a gift card, and so forth.

Due to advanced technologies of mobile devices, consumers frequently want to make payments using a mobile payment service. The mobile payment service is also referred to as mobile money or a mobile wallet. The mobile payment service is a payment service that enables a consumer to make payment via a mobile device based on a predetermined financial agreement or regulation. Instead of making a payment with cash, a consumer can use a mobile device such as user equipment including a smart phone to pay for a wide range of services and goods. The mobile payment service might be a different application form of a payment card. For example, a payment card might be issued through a mobile device and digitally installed in the mobile device. Furthermore, many payment card companies (e.g., credit card companies) provide a digital version of a payment card that can be digitally installed in a mobile device and used as a mobile payment.

Due to various convenient features thereof, the mobile payment service has been popular among consumers. In general, the mobile payment service is provided to a consumer through a service application installed and executed in user equipment in connection with an associated service server. In order to provide the mobile payment service, the user equipment may collect necessary information from a plurality of merchants, process the collected information, and provide such processed information to a consumer through a user interface of the executed service application. Such operations require the user equipment to have high processing power and a large memory space.

### SUMMARY

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present embodiment, a service may be provided for helping a consumer to select a payment card returning the relatively best benefits among multiple payment cards of the consumer without requiring user equipment for collecting a large amount of information and for performing excessive amount of computation.

In accordance with another aspect of the present invention, a service for selecting one of payment cards is provided through a service application installed and executed in user equipment by receiving a modularized code block from a service server, where the modularized code block contains information on beneficial payment cards associated with a target merchant.

In accordance with at least one embodiment, a method is provided for providing a mobile payment service to a consumer by user equipment. Such a method may include receiving a modularized code block associated with a target merchant from a service server and displaying information on beneficial payment cards associated with the target merchant in a designated display area of a user interface of a service application, installed in and executed by the user equipment, by processing the received modularized code block. The beneficial payment cards may be payment cards returning membership benefits to the consumer when the consumer uses the beneficial payment cards to make a payment for a purchase from the target merchant.

The receiving may include obtaining a merchant identification code from the target merchant and requesting the modularized code block in associated with the obtained merchant identification code to the service server.

The generating may include generating the modularized code block using a predetermined code language by processing the information on beneficial payment cards of the target merchant.

The information on beneficial payment cards may include card identification codes of beneficial payment cards classified by a payment card type and card identification codes of the classified beneficial payment cards sorted by a consumer preference of a member benefit type.

The displaying may include displaying basic elements of the user interface of the service application with the designated display area emptied by executing the service application installed in the user equipment and displaying the information on beneficial payment cards associated with the target merchant in the designated display area of the user interface.

The method may further include detecting beneficial payment cards owned by the consumer among the beneficial payment cards associated with the target merchant and displaying a display area of each one of the detected owned beneficial payment cards differently from others. The detecting may include registering owned payment cards at the service server, receiving information on card identification codes assigned to the registered owned payment cards from the service server, comparing the card identification codes assigned to the owned payment cards with card identification codes of the beneficial payment cards associated with the target merchant, and detecting the owned beneficial payment cards based on the comparison result.

The method may further include receiving a selection input for selecting one of the beneficial payment cards from the consumer, generating a payment request based on the selected beneficial payment card based on the received selection input, and transmitting the payment request to a payment terminal of the target merchant.

In accordance with at least one embodiment, a method may be provided for providing a mobile payment service to a consumer. The method of a service server may include generating a modularized code block using a predetermined code language by processing information on beneficial payment cards associated with a target merchant and providing the generated modularized code block in response to a request with a merchant identification code of the target merchant from user equipment. The beneficial payment cards are payment cards returning membership benefits to the consumer when the consumer uses the beneficial payment cards to make a payment for a purchase from the target merchant.

The method may include receiving a registration request from the target merchant and assigning the merchant identification code to the target merchant in response to the registration request.

The generating may include requesting information on the beneficial payment cards to the target merchant, receiving the requested information on the beneficial payment cards from the target merchant, processing the received information on the beneficial payment cards to the modularized code block, mapping the modularized code block to the merchant identification code of the target merchant, and storing the modularized code block with the merchant identification code in a form of a mapping table.

The generating may include receiving the information on the beneficial payment cards from the target merchant, classifying the beneficial payment cards by a payment card type, sorting the classified beneficial payment cards by a consumer preference of a benefit type, generating the modularized code block by processing the sorting result, and storing the generated modularized code block with the merchant identification code of the target merchant in a form of a mapping table.

The method may include receiving, from the user equipment, a request with a merchant identification code for an associated modularized code block and searching the associated modularized code block based on the merchant identification code included in the request.

The generating may include generating the modularized code block to be compatible with a device environment of the user equipment and generating the modularized code block to be displayed in a designated display area of a user interface of an associated service application installed and executed in the user equipment.

The generating may include generating the modularized code block using a hypertext markup language version 5 (HTLM 5).

The providing may include transmitting the modularized code block to the user equipment. In this case, the user equipment displays basic elements of a user interface of an associated service application with a designated display area emptied by processing the associated service application installed in the user equipment and displays the information on the beneficial payment cards associated with the target merchant in the designated display area of the user interface by processing the transmitted modularized code block.

The method may include receiving, from the user equipment, a request for registering payment cards owned by the consumer, assigning card identification codes to the owned payment cards, respectively, and providing information on the assigned card identification codes to the user equipment.

In accordance with at least one embodiment, user equipment may be provided for providing a mobile payment service to a consumer. The user equipment may be configured to obtain a merchant identification code from a target merchant, request a modularized code block associated with the obtained merchant identification code to a service server, receive a modularized code block associated with the merchant identification code from the service server, and display information on beneficial payment cards associated with the target merchant in a designated display area of a user interface of a service application, installed in and executed by the user equipment, by processing the received modularized code block. The beneficial payment cards may be payment cards returning membership benefits to the consumer when the consumer uses the beneficial payment cards to make a payment for a purchase from the target merchant.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 illustrates a payment card processing system in accordance with at least one embodiment;

FIG. 2 and FIG. 3 illustrate a method for providing a service of helping a consumer to choose a payment card that returns the relatively best membership benefits to the consumer in accordance with at least one embodiment;

FIG. 4 illustrates a modularized code block generated according to each merchant by a service server and stored at a service server in accordance with at least one embodiment;

FIG. 5 illustrates a modularized code block transmitted to and stored and displayed at user equipment in accordance with at least one embodiment;

FIG. 6 illustrates user equipment in accordance with at least one embodiment of the present invention; and

FIG. 7 illustrates a service server in accordance with at least one embodiment of the present invention.

### DESCRIPTION OF EMBODIMENTS

Reference will now be made in detail to embodiments of the present invention, examples of which are illustrated in the accompanying drawings, wherein like reference numerals refer to like elements throughout. The embodiments are described below, in order to explain the present invention by referring to the figures.

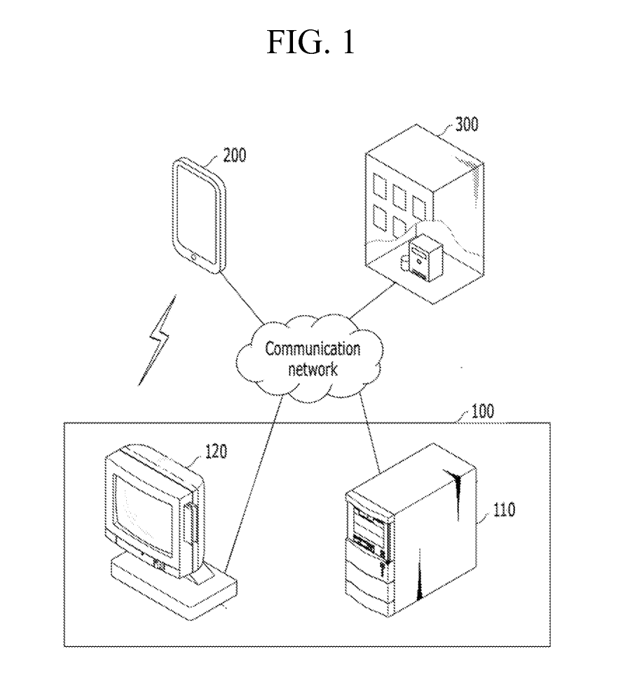

In accordance with at least one embodiment, a consumer is provided with a service for efficiently and conveniently selecting a payment card returning the relatively best benefits among multiple payment cards of the consumer without requiring user equipment for collecting a large amount of information and for performing excessive amount of computation. Such a service is provided through a service application installed and executed in user equipment by receiving a modularized code block from a service server, where the modularized code block contains information on beneficial payment cards associated with a target merchant. Hereinafter, a mobile payment service system where such a service is applied to will be described with reference to FIG. 1.

FIG. 1 illustrates a mobile payment service system in accordance with at least one embodiment.

Referring to FIG. 1, a mobile payment service system includes merchant system 100, user equipment 200, and service server 300. Merchant system 100 includes merchant server 110 and point-of-sale (POS) terminal 120. In the mobile payment service system, a service is provided to a consumer for effectively and conveniently selecting a payment card returning the relatively best membership benefits among payment cards belonging to the consumer in accordance with at least one embodiment.

Merchant server 110 stores information on goods or services offered by a merchant and information on payment cards that provide membership benefits to a consumer if the consumer uses the payment cards to make a payment for goods or services offered by the merchant. The payment card may be a card that can be used by a cardholder and accepted by a merchant to make a payment for a purchase or in payment of some other obligation. Such payment card includes a credit card, a debit card, an automated teller machine (ATM) card, a charge card, a stored-value card, a gift card, a membership card, a coupon, and so forth. A payment card returning membership benefits may be referred to as a beneficial payment card.

Merchant server 110 may provide POS terminal 120 with information necessary for processing a payment request received from user equipment 200 through POS terminal 120. Furthermore, merchant server 110 provides beneficial payment card information to service server 300 and user equipment 200 in response to a request from service server 300 and user equipment 200.

User equipment 200 is an electronic device that provides a consumer with a service for helping the consumer to choose a payment card that returns the relatively best membership benefits. Such a service might be provided through a service application installed in user equipment 200 in connection with service server 300. User equipment 200 may be any device used directly by an end-user to communicate and to perform operations associated with the service. User equipment 200 may include a hand-held telephone, a mobile phone, a smart phone, a personal digital assistance (PDA), a pad-like device, a laptop computer equipped with a mobile broadband adapter, and so forth.

User equipment 200 stores information on payment cards each associated with a card identification code. For example, user equipment 200 registers payment cards that an associated consumer owns at service server 300 and receives information on card identification codes assigned to each registered payment card. Such information may be stored in a form of a mapping table.

User equipment 200 obtains a merchant identification code of a merchant when an associated consumer wants to purchase a good or a service from the merchant. For example, user equipment 200 might obtain such an identification code from POS terminal 120 or merchant server 110 through communication therebetween or through scanning a code pattern image associated with the merchant.

User equipment 200 transmits the obtained merchant identification code to service server 300 and requests beneficial payment card information associated with the obtained merchant identification code in accordance with at least one embodiment. In response to the request, user equipment 200 receives processed beneficial payment card information associated with a target merchant from service server 300. The beneficial payment card information is associated with the identification code of the merchant. The requested beneficial payment card information is provided in a form of a modularized code block written in a predetermined code language such as a hypertext markup language 5 (HTML 5).

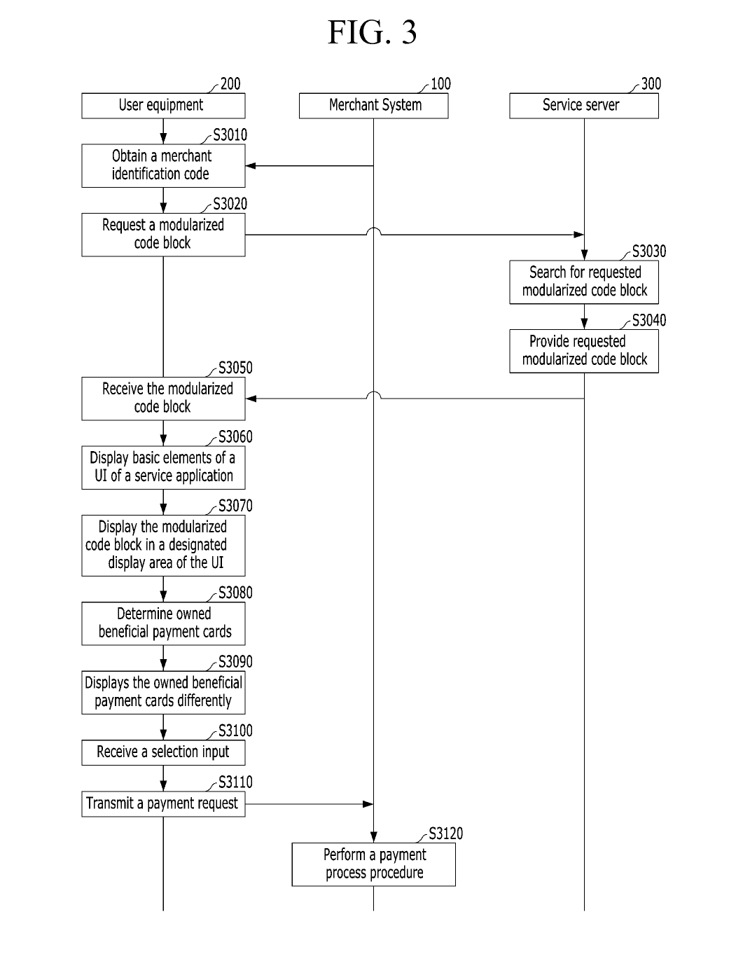

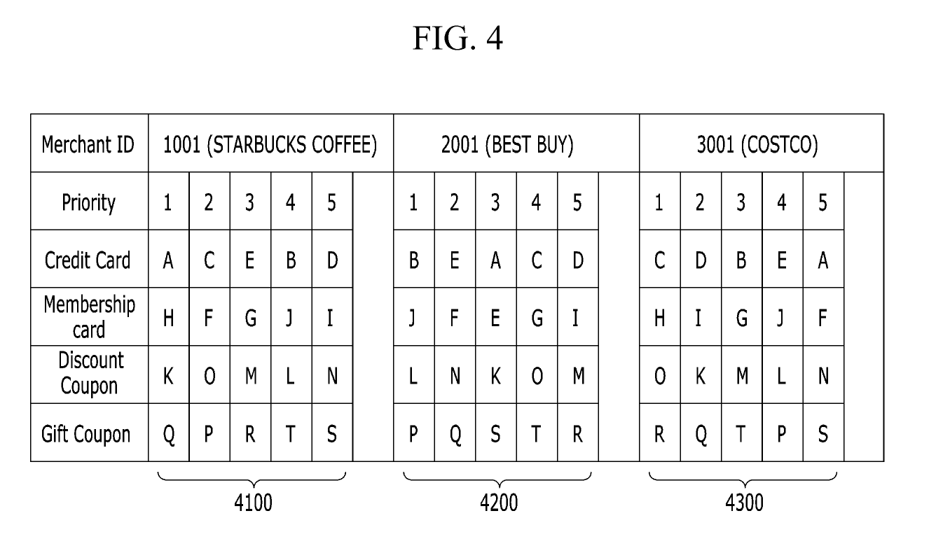

The beneficial payment card information contains information on payment cards returning membership benefits to a consumer if the consumer uses the payment cards to make a payment for a purchase from the merchant. Particularly, the beneficial payment card information includes a card identification code of each beneficial payment card. The beneficial payment card information includes information on beneficial payment cards classified by a payment card type and sorted by a consumer preference (e.g., preferred member benefit type). Such beneficial payment card information will be described in detail with reference to FIGS. 4 and 5.

Upon the receipt of the beneficial payment card information (e.g., modularized code block), user equipment 200 displays the received beneficial payment card information in a designated display area of a user interface displayed as a result of executing the service application downloaded from service server 300 and installed in user equipment 200. For example, user equipment 200 displays basic elements of the user interface of the service application with the designated display area emptied by executing the service application and displays the received beneficial payment card information in the designated display area of the user interface by processing the received modularized code block from service server 300 in accordance with at least one embodiment.

Furthermore, user equipment 300 detects beneficial payment cards the consumer owns based on the received beneficial payment card information and displays the detected beneficial payment cards differently from others in order to enable a consumer to indicate the owned beneficial payment cards in accordance with at least one embodiment. User equipment 200 receives a selection input for selecting one of the owned beneficial payment cards and transmits a payment request with information on the selected payment card to POS terminal 120 or merchant server 110.

Service server 300 is coupled to user equipment 200 and merchant system 100 through various types of communication network configurations. Service server 300 is a server of a company offering the service for helping a consumer to choose a payment card that will return the relatively best membership benefits.

Service server 300 provides an associated service application to user equipment 200. For example, user equipment 200 downloads the associated service application from service server 300 and installs the downloaded service application for providing such a service to a consumer.

Service server 300 performs operations for registering merchants as member merchants. Service server 300 regularly collects information on registered member merchants and information on beneficial payment cards associated with each member merchant from associated merchant system 100. Service server 300 assigns unique identification code to each member merchant and stores information on the member merchant and the associated beneficial payment card information in association with the identification code in a form of a mapping table.

Service server 300 generates a modularized code block by processing the beneficial payment card information of each member merchant. For example, service server 300 classifies beneficial payment cards of each member merchant by a payment card type, such as a credit card, a debit card, a membership card, a discount coupon, and a gift coupon. Service server 300 sorts the classified payment cards of each payment card type based on a consumer preference (e.g., preferred member benefit type such as a discount rate, a bonus point, and a cash back point). Service server 300 generates a modularized code block of the sorting result using a predetermined code language such as HTML 5 by processing the sorted result. For example, service server 300 generates such a modularized code block of the sorting result i) written in a predetermined standard code language such as HTML5, ii) to be compatible with a device environment of user equipment 200 and iii) to be displayed in a designated display area of a user interface of an associated service application installed and executed in user equipment 200. That is, the modularized code block is the processed beneficial payment card information that will be displayed in a designated display area of a user interface of an associated service application executed and displayed on user equipment 200. Service server 300 maps the sorting result to a corresponding merchant identification code and store the mapping result in a form of a mapping table. The operations for generating a modularized code block per each merchant are repeatedly performed at a regular interval in order to update new beneficial payment card information of each merchant.

Service server 300 provides such the processed beneficial payment card information in a form of a modularized code block to user equipment 200 in response to a request from user equipment. Such provided beneficial payment card information includes card identification codes of beneficial payment cards.

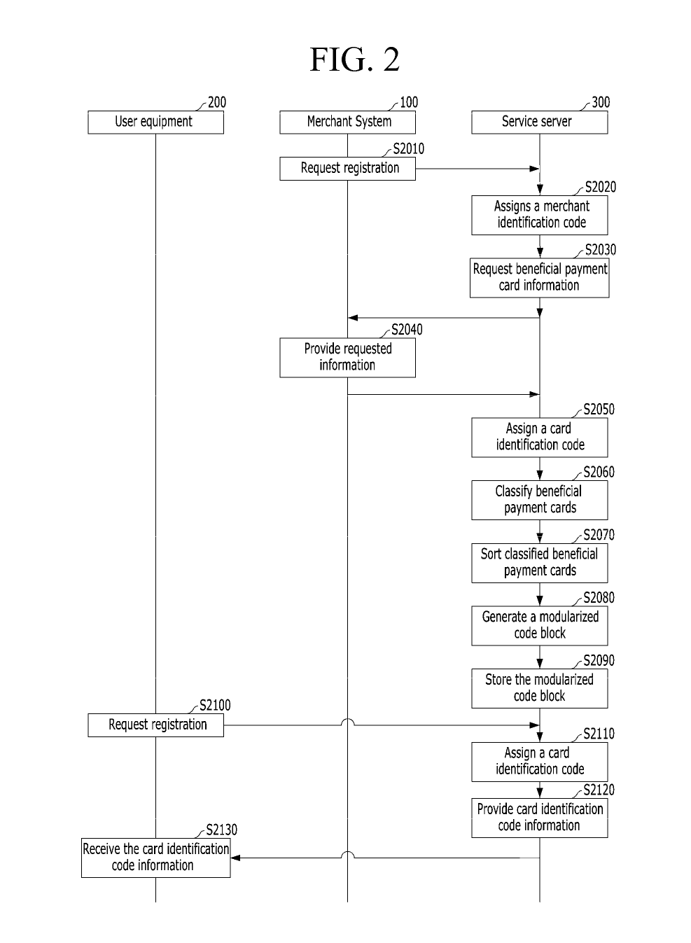

As described, a service for helping a consumer to efficiently and conveniently choose one of payment cards is provided through an application installed and executed in user equipment 200 by receiving a modularized code block from service server 300, where the modularized code block contains information on beneficial payment cards associated with a target merchant. Particularly, user equipment 200 obtains a merchant identification code from merchant system 100 and provides the obtained merchant identification code to service server 300. Service server 300 computes beneficial payment cards associated with the merchant identification code, processes the computed beneficial payment cards into a modularized code block, and provides the modularized code block to user equipment 200. Upon the receipt of the modularized code block, user equipment 200 displays a user interface of a service application with a designated display area emptied by performing operations associated with the service application installed in user equipment 200 and displays beneficial payment card information in the designated contents area by executing the received modularized code block. Accordingly, user equipment 200 does not necessarily need to compute or otherwise initiates a complicated operation requiring excessive processing power for classifying and sorting beneficial payment cards of each member merchant and a large memory space for collecting the beneficial payment card information from each member merchant. Furthermore, user equipment 200 does not need to update an entire service application for obtaining new beneficial payment card information of each member merchant when beneficial payment card information of each merchant is changed. Such operation of user equipment 200 and service server 300 will be described in detail with reference to FIG. 2, FIG. 3, FIG. 4, and FIG. 5.

FIG. 2 and FIG. 3 illustrates a method for providing a service of helping a consumer to choose a payment card that returns the relatively best membership benefits to the consumer in accordance with at least one embodiment. FIG. 4 illustrates a modularized code block generated according to each merchant by a service server and stored at a service server in accordance with at least one embodiment. FIG. 5 illustrates a modularized code block transmitted to and stored and displayed at user equipment in accordance with at least one embodiment.

Referring to FIG. 2, merchant system 100 requests registration as a member merchant to service server 300 at step S2010. For example, merchant system 100 may transmit a registration request message with information on a merchant to service server 300. The information on merchant may contain various types of information including a name of a merchant and an Internet Protocol (IP) address of a merchant system (e.g., merchant server 110 or POS terminal 120).

At step S2020, service server 300 performs a registration procedure including assigning of a unique merchant identification code to merchant system 100 in response to the request. For example, service server 300 may assign a numeral code as a merchant identification code to a requested merchant, but the present invention is not limited thereto. Such a format of a merchant identification code may be various. The format of the merchant identification code may be determined by a service provider (e.g., service server 300) or agreement between a merchant and a service provider. For convenience and ease of understanding, a four numeral digit code is described as being assigned as a merchant identification code. For example, “Starbuckscoffee” is assigned with “1001”, “Best By” is assigned with “2001”, and “Costco” is assigned with “3001”.

At step S2030, service server 300 requests information on beneficial payment cards to merchant system 100. The beneficial payment cards are payment cards that will return membership benefits to a consumer if the consumer uses the payment cards to make a payment for goods or services from a merchant associated with merchant system 100. The membership benefits may be a discount rate, a bonus point, or a cash back. For example, “Starbucks” coffee shop offers 10% discount to a consumer if the consumer uses a credit card “A”. In this case, the credit card “A” is a beneficial payment card of a merchant of “Starbucks”.

At step S2040, merchant system 100 provides the requested beneficial payment card information to service server 300 in response to the request. For example, merchant system 100 transmits information on predetermined payment cards that will returns predetermined membership benefits to a consumer when the consumer buys goods or services using the predetermined payment cards.

At step S2050, service server 300 receives the information on the beneficial payment cards associated with a merchant of merchant system 100 and assigns a unique card identification code to each beneficial payment card. For example, service server 300 may assign a numeral code as a card identification code to each beneficial payment card associated with the merchant of merchant system 100, but the present invention is not limited thereto. Such a format of a card identification code may be various. The format of the card identification code may be determined by a merchant, a consumer, a service provider (e.g., service server 300) or agreement between a merchant and a service provider. Furthermore, service server 300 assigns the same card identification code to the same type of payment cards. For example, service server 300 assigns a card identification code of “A” to a Citibank Prestige credit card and a card identification code of “B” to an American Express Gold credit card. The present invention, however, is not limited thereto. For convenience and ease of understanding, an alphabetic code is described as being assigned to each beneficial payment card.

After receiving the beneficial payment card information from a registered member merchant, service server 300 processes the received beneficial payment card information of each merchant in a form of a modularized code block using a predetermined code language such as HTML 5, as shown in FIG. 4 and FIG. 5. Hereinafter, such a procedure of processing the received beneficial payment card information of each merchant in a modularized code block will be described.

At step S2060, service server 300 classifies beneficial payment cards by a payment card type, such as a credit card, a debit card, a membership card, a discount coupon, and a gift coupon. As shown in FIG. 4, beneficial payment cards associated with each merchant are classified by a payment card type. For example, service server 300 receives information on twenty beneficial payment cards from merchant system 100 of “Starbucks”. Service server 300 classifies the beneficial payment cards associated with “Starbucks” by each card type, such as a credit card, a membership card, a discount coupon, and a gift coupon. As a result, the beneficial payment cards associated with “Starbucks” are classified into five credit cards A, B, C, D, E: five membership cards F, G, H, I, J: five discount coupons K, L, M, N, O: and five gift coupons P, Q, R, S, T.

At step S2070, service server 300 sorts the classified payment cards of each payment card type based on a consumer preference. For example, the consumer preference may be one of membership benefit types, such as a discount rate, a bonus point, and a cash back point. Such consumer preference may be determined by a service provider, a consumer, or agreement between a consumer and a service provider, but the present invention is not limited thereto. As shown in FIG. 4, the classified payment cards are sorted based on a predetermined consumer preference such as a discount rate. The credit cards are sorted in an order of “A, C, E, B, D”: the membership cards are sorted in an order of “H, F, G, J, I”: the discount coupons are sorted in an order of “K, O, M, L, N”: and the gift coupons are sorted in an order of “Q, P, R, T, S”.

At step S2080, service server 300 generates a modularized code block of the sorting result using a predetermined code language such as hypertext markup language 5 (HTML 5) by processing the sorted result. For example, service server 300 generates such a modularized code block of the sorting result i) written in a predetermined standard code language such as HTML5, ii) to be compatible with a device environment of user equipment 200 and iii) to be displayed in a designated display area of a user interface of an associated service application installed and executed in user equipment 200. That is, the modularized code block is the processed beneficial payment card information that will be displayed in a designated display area of a user interface of an associated service application executed and displayed on user equipment 200.

For example, the sorting result of beneficial card information of the “Starbucks” coffee shop is processed as modularized code block 4100, a sorting result of beneficial card information of the “best buy” is processed as modularized code block 4200, and a sorted result of beneficial card information of the “Costco” is processed as modularized code block 4300 as shown in FIG. 4.

At step S2090, service server 300 maps the sorted result to a corresponding merchant identification code and stores the mapping result in a form of a mapping table. For example, service server 300 maps modularized code block 4100 with the merchant identification code 1001 (e.g., Starbucks), maps modularized code block 4200 with the merchant identification code 2001 (e.g., Best buy), and maps modularized code block 4300 with the merchant identification code 3001 (e.g., Costco). The modularized code blocks (e.g., processed beneficial payment card information) each mapped with an associated merchant identification code are stored in a form of a mapping table as shown in FIG. 4.

The operations for generating a modularized code block per each merchant (e.g., steps S2050 to S2090) are repeatedly performed at a regular interval in order to update new beneficial payment card information of each merchant.

At step S2100, user equipment 200 requests registration of owned payment cards to service server 300. For example, a user (e.g., a consumer) registers owned payment cards through user equipment 200. Such registration may be performed through a service application downloaded from service server 300 and installed in user equipment 200. That is, a user initiates such a service application installed in user equipment 200. User equipment 200 displays a user interface for registering payment cards at service server 300. The user might enter information on payment cards through the user interface for registration.

At step S2110, service server 300 performs a registration procedure including assigning of a payment card identification code to each registered payment card. in response to the registration request. For example, service server 300 receives the registration request with information on owned payment cards from user equipment 200. Service server 300 assigns a unique card identification code to each one of owned payment cards. As described, service server 300 may assign a numeral code as a card identification code to each one of the owned payment cards, but the present invention is not limited thereto. Such a format of a card identification code may be various. The format of the card identification code may be determined by a merchant, a consumer, a service provider (e.g., service server 300) or agreement between a merchant and a service provider. Furthermore, service server 300 assigns the same card identification code to the same type of payment cards. That is, the same card identification code is assigned to the owned payment card and the beneficial payment card if the payment cards are the same type of payment cards.

At step S2120, service server 300 provides information on the assigned card identification code to user equipment 200. At step S2130, user equipment 200 receives the information on the assigned payment card identification code of each owned payment card and stores the received information.

Hereinafter, a method of receiving a modularized code block associated with an obtained merchant identification code from a service server and displaying processed beneficial payment card information based on the received modularized code block in accordance with at least one embodiment will be described with reference to FIG. 3.

Referring to FIG. 3, user equipment 200 obtains a merchant identification code from merchant system 100 at step S3010. For example, when a consumer wants to make a payment for a purchase from a merchant, a consumer obtains a merchant identification code of the merchant using user equipment 200. Such operation may be performed through a service application downloaded from service server 300 and installed at user equipment 200. That is, the consumer initiates the service application installed in user equipment 200 and the initiated application obtains a merchant identification code from merchant system 100. Such a merchant identification code may be obtained by i) receiving a merchant identification code from POS terminal 120 or merchant server 110 through a communication link established therebetween, ii) scanning a code pattern image of a merchant identification code of a merchant, and iii) receiving an input of a merchant identification code from a consumer through an input device of user equipment 200.

At step S3020, user equipment 200 requests a modularized code block (e.g., processed beneficial payment card information) associated with the obtained merchant identification code to service server 300 by transmitting the obtained merchant identification code to service server 300. For example, user equipment 200 transmits a request message to service server 300 for beneficial payment card information associated with the merchant. That is, user equipment 200 requests for a modularized code block mapped to the obtained merchant identification code.

At step S3030, in response to the request, service server 300 searches for a modularized code block based on the received merchant identification code through the mapping table stored in a memory of service server 300. That is, service server 300 searches for processed beneficial payment card information associated with the received merchant identification code. For example, when service server 300 receives a merchant identification code of “1001” (e.g., Starbucks), service server 300 searches for a modularized code block mapped with the merchant identification code of “1001”. That is, service server 300 fetches modularized code block 4100 as shown in FIG. 4.

At step S3040, service server 300 provides the modularized code block associated with the received merchant identification code to user equipment 200. For example, service server 300 transmits modularized code block 4100 mapped with the identification code of “1001” to user equipment 200. As described, modularized code block 4100 is processed beneficial payment card information associated with a merchant of “Starbucks”. The processed beneficial payment card information includes information on beneficial payment cards classified by a payment card type and sorted based on a predetermined consumer preference.

At step S3050, user equipment 200 receives the modularized code block associated with the obtained merchant identification code from service server 300. For example, user equipment 200 receives modularized code block 4100 associated with the obtained merchant identification code (e.g., 1001) as shown in a diagram (a) of FIG. 5.

At step S3060, user equipment 200 displays basic elements of a user interface of an associated service application with a designated display area emptied. For example, user equipment 200 displays frame 510, menu 520, merchant and payment information 530, and emptied designated display area 540 as shown in a diagram (b) of FIG. 5. Designated display area 540 is a display area for displaying the processed beneficial payment card information obtained from service server 300. That is, user equipment 200 obtains information and performs operations, which require simple computation, less processing power, and a small amount of memory space, as compared to collecting beneficial payment card information from each member merchant, processing the collected beneficial payment card information of each merchant by classifying and sorting beneficial payment cards of each member merchant, generating a modularized code block per processed beneficial payment card information of each merchant, and storing such generated modularized code block of each merchant in a form of a mapping table.

At step S3070, user equipment 200 displays the processed beneficial payment card information associated with the obtained merchant identification code within the designated display area by processing the received modularized code block. For example, user equipment 200 processes modularized code block 4100 associated with the obtained merchant identification code (e.g., 1001) and displays, as the result of processing, the processed beneficial payment card information associated with the merchant “Starbucks” in designated display area 540, as shown in a diagram (c) of FIG. 5.

At step S3080, user equipment 200 determines, as an owned beneficial payment card, which beneficial payment cards a user thereof owns by comparing the stored card identification codes of the owned payment cards with card identification codes of the beneficial payment cards included in the modularized code block.

At step S3090, user equipment 200 displays a display area corresponding to the owned beneficial payment card differently than other beneficial payment cards. For example, user equipment 200 display blocks of the owned beneficial payment cards with shade or little darker than others as shown in display block 550 in a diagram (c) of FIG. 5.

As shown in FIG. 5, the user interface of the service application shows beneficial payment cards associated with the merchant of Starbucks coffee shop, which classified into a credit card, a membership card, a discount coupon, and a gift coupon and are sorted by a consumer preference of a discount rate. The user interface also shows beneficial payment cards that the consumer owns. Accordingly, the consumer can efficiently and conveniently selects one that will return the relatively best membership benefits to the consumer from a plurality of payment cards that the consumer owns.

At step S3100, user equipment 200 receives a selection input for selecting one of the owned payment cards from the consumer. At step S3110, user equipment 200 transmits a payment request with information on the selected payment card to merchant system 100 (e.g., POS terminal 120). At step S3120, merchant system 100 performs a payment process procedure with the received payment request.

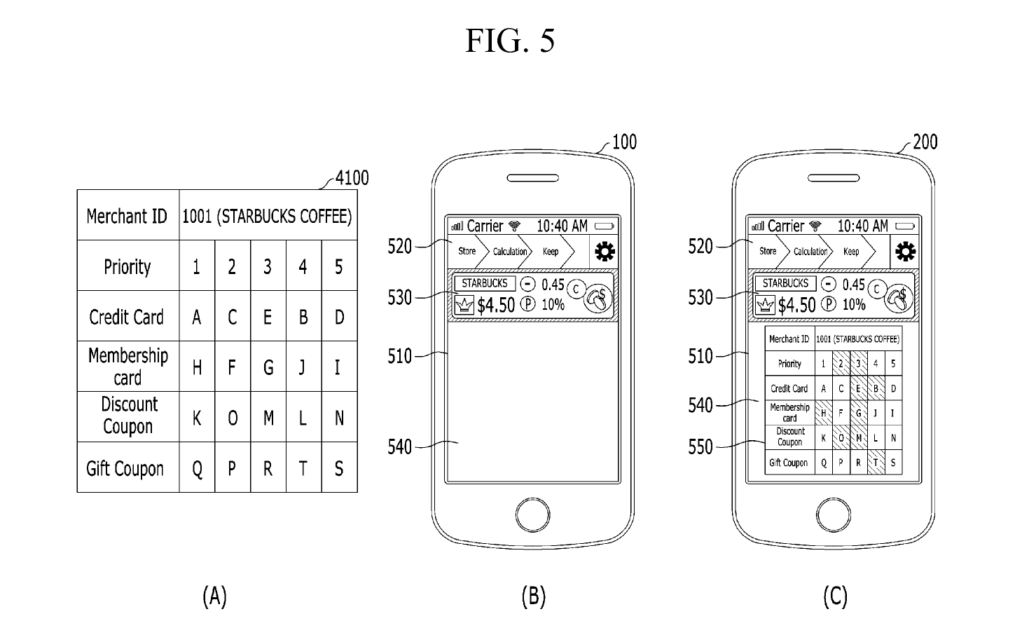

FIG. 6 illustrates user equipment in accordance with at least one embodiment of the present invention.

Referring to FIG. 6, user equipment 200 includes communication circuit 210, memory 220, input circuit 230, output circuit 240, and processor 250. Although user equipment 200 is illustrated as including five constituent elements, the present invention is not limited thereto. User equipment 200 may further include various elements such as a camera, a sensor, and an interface circuit.

Communication circuit 210 transmits and receives signals to/from other entities (e.g., merchant system 100 and service server 300) through a communication network based on various types of communication schemes. For convenience and ease of understanding, user equipment 200 is illustrated as having one communication circuit in FIG. 6, but the present invention is not limited thereto. For example, user equipment 200 may include more than two communication circuits each employing a different communication scheme. Communication circuit 210 may be referred to as a transceiver and include at least one of a mobile communication circuit, a wireless internet circuit, a near field communication (NFC) circuit, a global positioning signal receiving circuit, and so forth. Particularly, communication circuit 210 may include a short distance communication circuit for short distance communication, such as NFC, and a mobile communication circuit for long range communication through a mobile communication network, such as long term evolution (LTE) communication or wireless data communication (e.g., WiFi). Through the short distance communication circuit, user equipment 200 might communicate with POS terminal 120. Through the mobile communication circuit, user equipment 200 might communicate with service server 300 or merchant server 100 through various types of communication networks.

In accordance with at least one embodiment, communication circuit 210 transmits a registration request message with information on payment cards owned by an associated user (e.g., associated a consumer) to service server 300. Communication circuit 210 receives information on card identification codes assigned to the owned payment cards from service server 300 as a result of the registration. Communication circuit 210 receives information on a merchant identification code from merchant system 100 through a wireless link or a wired link established between user equipment 200 and merchant system 100 (e.g., POS terminal 120 and merchant server 110). Communication circuit 210 transmits a request message for a modularized code block associated with the obtained merchant identification code. In addition, communication circuit 210 receives a requested modularized code block from service server 300.

Memory 220 stores various types of data including operating system for controlling user equipment 200 and at least one application necessary for providing a service to help a consumer to efficiently and conveniently select a payment card that will return the relatively best membership benefits. For example, memory 220 may store an application for requesting an associated service server (e.g., service server 300) to register a payment card that a consumer owns, an application for entering information on a payment card to register at the associated service server, an application for displaying basic elements of a user interface with a designated emptied display area, an application for displaying a modularized code block (e.g., processed beneficial payment card information) in the designated display area of the user interface, and so forth. Furthermore, memory 220 stores various types of data generated during performing operations in user equipment 200.

Memory 220 stores information on card identification codes respectively assigned to owned payment cards and information on a modularized code block received from service server 300. In addition, memory 220 stores information on payment cards that an associated user owns, information on a merchant identification code from merchant system 100, and so forth.

Input circuit 230 receives various types of inputs for performing operations associated with a service for helping a consumer to efficiently and conveniently choose a payment card retuning the relatively best membership benefits. For example, input circuit 230 may receive an input that initiates an application for an associated service application, an input for entering information on payment cards from a user, an input that requests the registration of payment cards to service server 300, an input for obtaining a merchant identification code from merchant system 100, an input for requesting a modularized code block (e.g., processed beneficial payment card information) associated with the obtained merchant identification code, an input for making a payment of a purchase with the selected payment card, and so forth. Such input circuit 230 may be a touch screen disposed on output circuit 240. In addition, input circuit 230 may be a key pad or buttons.

Output circuit 240 displays various types of data, message, and user interfaces, which are generated in user equipment 200. Output circuit 240 displays results of performing operations based on the received input through a graphic user interface. Output circuit 240 displays various graphic user interfaces as a result of executing service applications downloaded from service server 300 and installed at user equipment 200 for providing the service. For example, output circuit 240 displays at least one of a user interface for registering payment cards, a user interface for receiving information on payment cards, a user interface for obtaining a merchant identification code from merchant system 100, a user interface for requesting beneficial payment card information associated with the obtained merchant identification code to service server 300, a user interface for displaying basic elements of a user interface with a designated emptied display area, a user interface for displaying the beneficial payment card information in the designated display area, and so forth. Particularly, output circuit 240 displays a user interface showing beneficial payment cards associated with a target merchant as shown in FIG. 5.

Processor 250 is a central processing circuitry that controls constituent elements of user equipment 200, such as communication circuit 210, memory 220, input circuit 230, and output circuit 240 based on inputs received through input circuit 230 or based on results of performing operations associated with the service.

In accordance with at least one embodiment, processor 250 performs operations for registering payment cards at service server 300 through communication circuit 210. Processor 250 performs operations for obtaining a merchant identification code from merchant system 100 through input circuit 230 and/or communication circuit 210, but the present invention is not limited thereto. Such operation may be performed through other elements such as a camera. The operations for registration and for obtaining the merchant identification code may be performed by executing a service application installed in user equipment 200.

Furthermore, processor 250 performs operations for requesting beneficial payment card information (e.g., modularized code block) associated with the obtained merchant identification code to service server 300 through communication circuit 210. Processor 250 also performs operations for receiving the requested beneficial payment card information from service server 300 through communication circuit 210. In addition, processor 250 performs operations for displaying basic elements of a user interface of the service application with a designated emptied display area and displaying the received beneficial payment card information in the designated display area by processing an associated modularized code block through output circuit 240.

Processor 250 performs operations for detecting beneficial payment cards associated with a target merchant among owned payment cards and displaying display areas of the detected beneficial payment cards differently from display areas of other beneficial payment cards in the designated display area through output circuit 240. Processor 250 also performs operations for receiving selection inputs from a user through input circuit 230 and performs operations for generating a payment request based on the selection input and transmitting the generated payment request to merchant system 100 through communication circuit 210. Processor 250 may perform the above operations through executing a service application downloaded from service server 300 and installed in user equipment 200.

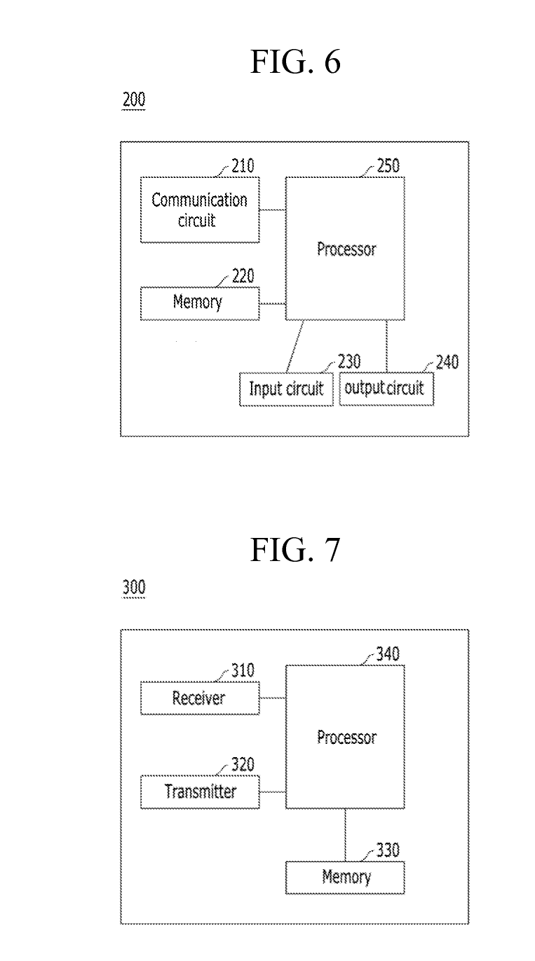

As described, user equipment 200 receives processed beneficial payment card information from service server 300 to provide the service for helping a consumer to effectively and conveniently choose a payment card that will return the relatively best membership benefits. Hereinafter, service server 300 for collecting beneficial payment card information from each merchant and generating a modularized code block of each merchant by processing the collected beneficial payment card information in accordance with at least one embodiment will be described with reference to FIG. 7.

FIG. 7 illustrates a service server in accordance with at least one embodiment of the present invention.

Referring to FIG. 7, service server 300 includes receiver 310, transmitter 320, memory 330, and processor 340. Although service server 300 is illustrated as including four constituent elements, the present invent is not limited thereto.

Receiver 310 receives various types of signals, data, and messages from user equipment 200 and merchant system 100. For example, receiver 310 receives a request for registering payment cards from user equipment 200, a request for registering member merchants from merchant system 100, beneficial payment card information from merchant system 100, a request for processed beneficial payment card information from user equipment 200, and so forth.

Transmitter 320 transmits signals, data, and message to user equipment 200 and merchant system 100. For example, transmitter 320 transmits service applications associated with a service for helping a consumer to efficiently and conveniently choose a payment card that will return the relatively best membership benefits. Transmitter 320 transmits information on card identification codes assigned to registered payment cards to user equipment 200. Transmitter 320 transmits processed beneficial payment card information (e.g., modularized code block) associated with a target merchant (e.g., merchant identification code received from user equipment 200) to user equipment 200.

Memory 330 stores applications necessary for providing the service, information on user equipment (e.g., user equipment 200) and merchants (e.g., merchant system) registered as a member for the service, information on registered payment cards of user equipment 200, information on card identification codes assigned to the registered payment cards, information on merchant identification codes assigned to member merchants, and so forth. Furthermore, memory 330 stores processed beneficial payment card information (e.g., modularized code block) of each merchant in a form of a mapping table as shown in FIG. 4.

Processor 340 is a central processing circuitry for performing operations for providing the service for helping a consumer to efficiently and conveniently choose a payment card returning the relatively best membership benefits in accordance with at least one embodiment. For example, processor 340 performs operations of assigning a merchant identification code to each member merchant and requesting beneficial payment card information to each member merchant through receiver 310 and transmitter 320.

Processor 340 also performs operations of receiving beneficial payment card information from each member merchant, classifying beneficial payment cards of each member merchant by a payment card type, and sorting the classified beneficial payment cards by a consumer preference (e.g., preferred membership benefits). Processor 340 performs operations of generating a modularized code block using a predetermined code language such as HTML 5 by processing the sorting result, mapping the modularized code block with an associated merchant identification code, and storing the mapping result in a form of a mapping table.

Processor 340 performs operations of assigning card identification codes to each registered payment card from user equipment 200 and providing information on the assigned card identification codes to user equipment 200. Processor 340 performs of searching a modularized code block (e.g., processed beneficial payment card information) associated with a received merchant identification code from user equipment 200 and provides the modularized code block to user equipment 200.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of providing a mobile payment service to a consumer by user equipment, the method comprising:
receiving a modularized code block associated with a target merchant from a service server; and
displaying information on beneficial payment cards associated with the target merchant in a designated display area of a user interface of a service application, installed in and executed by the user equipment, by processing the received modularized code block,
wherein the beneficial payment cards are payment cards returning membership benefits to the consumer when the consumer uses the beneficial payment cards to make a payment for a purchase from the target merchant.

2. The method of claim 1, wherein the receiving comprises:
obtaining a merchant identification code from the target merchant; and
requesting the modularized code block associated with the obtained merchant identification code to the service server.

3. The method of claim 1, wherein the generating comprises:
generating the modularized code block using a predetermined code language by processing the information on beneficial payment cards of the target merchant.

4. The method of claim 1, wherein the information on beneficial payment cards includes:
card identification codes of beneficial payment cards classified by a payment card type; and
card identification codes of the classified beneficial payment cards sorted by a consumer preference of a member benefit type.

5. The method of claim 1, wherein the displaying comprises:
displaying basic elements of the user interface of the service application with the designated display area emptied by executing the service application installed in the user equipment; and
displaying the information on beneficial payment cards associated with the target merchant in the designated display area of the user interface.

6. The method of claim 1, comprising:
detecting beneficial payment cards owned by the consumer among the beneficial payment cards associated with the target merchant; and
displaying a display area of each one of the detected owned beneficial payment cards differently from others.

7. The method of claim 6, wherein the detecting comprises:
registering owned payment cards at the service server;
receiving information on card identification codes assigned to the registered owned payment cards from the service server;
comparing the card identification codes assigned to the owned payment cards with card identification codes of the beneficial payment cards associated with the target merchant; and
detecting the owned beneficial payment cards based on the comparison result.

8. The method of claim 1, comprising:
receiving a selection input for selecting one of the beneficial payment cards from the consumer;
generating a payment request based on the selected beneficial payment card based on the received selection input; and
transmitting the payment request to a payment terminal of the target merchant.

9. A method of providing a mobile payment service to a consumer by a service server, the method comprising:
generating a modularized code block using a predetermined code language by processing information on beneficial payment cards associated with a target merchant; and
providing the generated modularized code block in response to a request with a merchant identification code of the target merchant from user equipment,
wherein the beneficial payment cards are payment cards returning membership benefits to the consumer when the consumer uses the beneficial payment cards to make a payment for a purchase from the target merchant.

10. The method of claim 9, comprising:
receiving a registration request from the target merchant; and
assigning the merchant identification code to the target merchant in response to the registration request.

11. The method of claim 9, wherein the generating comprises:
requesting information on the beneficial payment cards from the target merchant;
receiving the requested information on the beneficial payment cards from the target merchant;
processing the received information on the beneficial payment cards to the modularized code block;
mapping the modularized code block to the merchant identification code of the target merchant; and
storing the modularized code block with the merchant identification code in a form of a mapping table.

12. The method of claim 9, wherein the generating comprising:
receiving the information on the beneficial payment cards from the target merchant;
classifying the beneficial payment cards by a payment card type;
sorting the classified beneficial payment cards by a consumer preference of a benefit type;
generating the modularized code block by processing the sorting result; and
storing the generated modularized code block with the merchant identification code of the target merchant in a form of a mapping table.

13. The method of claim 9, comprising:
receiving, from the user equipment, a request with a merchant identification code for an associated modularized code block; and
searching the associated modularized code block based on the merchant identification code included in the request.

14. The method of claim 9, wherein the generating comprises:
generating the modularized code block compatible with a device environment of the user equipment; and
generating the modularized code block for display in a designated display area of a user interface of an associated service application installed and executed in the user equipment.

15. The method of claim 9, the generating comprising:
generating the modularized code block using a hypertext markup language version 5 (HTLM 5).

16. The method of claim 9, wherein the providing comprising:
transmitting the modularized code block to the user equipment,
wherein the user equipment:
displays basic elements of a user interface of an associated service application with a designated display area emptied by processing the associated service application installed in the user equipment; and
displays the information on the beneficial payment cards associated with the target merchant in the designated display area of the user interface by processing the transmitted modularized code block.

17. The method of claim 9, comprising:
receiving, from the user equipment, a request for registering payment cards owned by the consumer;
assigning card identification codes to the owned payment cards, respectively; and
providing information on the assigned card identification codes to the user equipment.

18. User equipment providing a mobile payment service to a consumer, the user equipment configured to:
obtain a merchant identification code from a target merchant;
request a modularized code block associated with the obtained merchant identification code to a service server;
receive a modularized code block associated with the merchant identification code from the service server; and
display information on beneficial payment cards associated with the target merchant in a designated display area of a user interface of a service application, installed in and executed by the user equipment, by processing the received modularized code block,
wherein the beneficial payment cards are payment cards returning membership benefits to the consumer when the consumer uses the beneficial payment cards to make a payment for a purchase from the target merchant.

19. The user equipment of claim 18, wherein the user equipment is configured to:
display basic elements of the user interface of the service application with the designated display area emptied by executing the service application installed in the user equipment; and
display the information on beneficial payment cards associated with the target merchant in the designated display area of the user interface by processing the received modularized code block from the service server.

20. The user equipment of claim 18, wherein the service is configured to:
receive information on the beneficial payment cards from the target merchant;
classify the beneficial payment cards by a payment card type;
sort the classified beneficial payment cards by a consumer preference of a benefit type;
generate the modularized code block by processing the sorting result;
store the generated modularized code block with the merchant identification code of the target merchant in a form of a mapping table; and
transmit the modularized code block to the user equipment in response to a request with the merchant identification code from the user equipment.
